(19) United States
(12) Patent Application Publication
(10) Pub. No.: US 2020/0113320 A1
(43) Pub. Date: Apr. 16, 2020

(54) SEMI-RIGID BELT/BODY-WORN VEHICLE KEY FOB CARRIER

(71) Applicant: Seth Taylor Simpson, Garner, NC (US)

(72) Inventor: Seth Taylor Simpson, Garner, NC (US)

(21) Appl. No.: 16/158,795

(22) Filed: Oct. 12, 2018

(51) Int. Cl. A45F 5/02; H04B 1/3888

(52) U.S. Cl. CPC A45F 5/021; A45F 2200/0558; H04B 1/3888

(57) ABSTRACT

A wearable carrier device for electronic devices wherein the carrier device provides an enclosure for removably housing the electronic device in an operable condition. In the operable condition, a user interface of the electronic device is accessible through a display opening, wherein the display opening communicates with the enclosure. The electronic device is easily accessible through an access opening for detaching the electronic device from the carrier device.

### BACKGROUND OF THE INVENTION

The present invention relates to belt mounted accessories and, more particularly, to a semi-rigid carrier device that mounts on a belt to secure a key fob or other portable electronic device in an operable condition, so that the key fob can be readily detached for use yet immediately operated while secured in the operable condition.

Compared to traditional keys, key fobs provide the convenience of electronically locking and unlocking a device, such as the doors of a vehicle. Key fobs, however, can still be lost like traditional keys, as well as still be difficult to pull from one's pockets like old fashion keys. The latter disadvantage can be devastating in an emergency, while the former disadvantage can ruin a user's entire day. Moreover, current holders for key fobs can prevent rapid access to a key fob, as the holder tends to encase the key fob in a retaining device that cannot be opened or accessed in a hurry. In short, there are currently no wearable semi-rigid key fob holders for immediate detachability or operability while in a secured condition.

As can be seen, there is a need for a semi-rigid carrier device that mounts on a belt to secure a key fob or other portable electronic device in an operable condition, so that the key fob can be readily detached for use or immediately operated while being secured. The carrier device provides fob button access while the fob key is retained in a secured condition. Thereby, the carrier device embodied by the present invention prevents lost key fobs as well as enables rapid access and operability times in normal and emergency situations. The present invention provides immediate fob and fob button access by being wearable with the fob buttons facing out through an accessible cut-out which allows access to those buttons at all times.

### SUMMARY OF THE INVENTION

In one aspect of the present invention, a carrier device for an electronic device having a user interface includes a body provide an access opening communicating an enclosure, both access opening and enclosure dimensioned to slidably receive the electronic device; the enclosure defined by two spaced apart substantially coextensive first and second end walls and a sidewall interconnecting a periphery of each end wall except for a portion of each periphery shared with a periphery of the access opening; and the first wall providing a display opening dimensioned to circumscribe the user interface.

In another aspect of the present invention, the carrier device for a key fob having a user interface includes a body provide an access opening communicating an enclosure, both access opening and enclosure dimensioned to slidably receive the key fob, wherein the key fob is movable through the access opening between a detached condition and an operable condition secured in the enclosure; the enclosure defined by two spaced apart substantially coextensive first and second end walls and an accordion-like sidewall interconnecting a periphery of each end wall except for a portion of each periphery shared with a periphery of the access opening; the first wall providing a display opening dimensioned to circumscribe the user interface in the operable condition; a loop disposed along the second end wall; and a drain hole provided along a lower portion of the sidewall, wherein the accordion-like sidewall enables the two end walls to move relative to each other when urged from the enclosure, and wherein the accordion-like sidewall is more rigid than the two spaced apart end walls in terms being movable in an outward direction from the enclosure.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is an enlarged perspective view of an exemplary embodiment of the present invention;

FIG. 3 is an exploded perspective view of an exemplary embodiment of the present invention;

FIG. 4 is an exploded perspective view of an exemplary embodiment of the present invention; and

FIG. 5 is a bottom perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a wearable carrier device for electronic devices wherein the carrier device provides an enclosure for removably housing the electronic device in an operable condition. In the operable condition, a user interface of the electronic device is accessible through a display opening, wherein the display opening communicates with the enclosure. The electronic device is easily accessible through an access opening for detaching the electronic device from the carrier device.

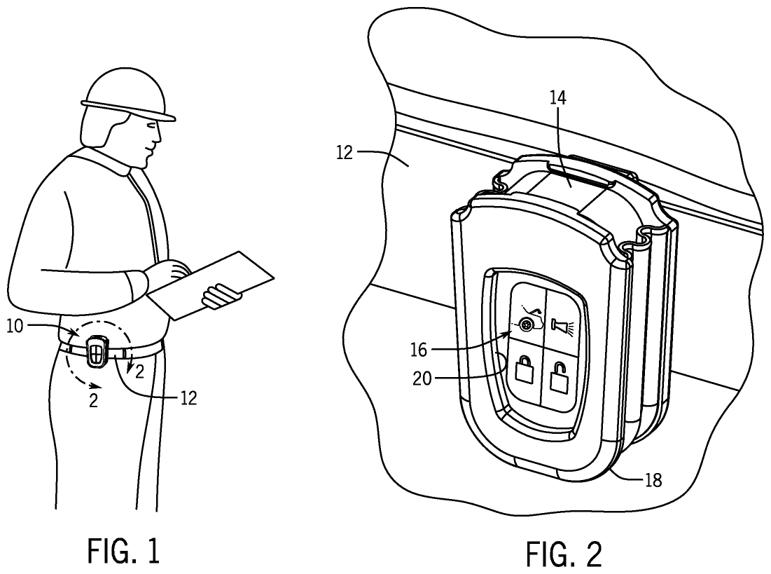

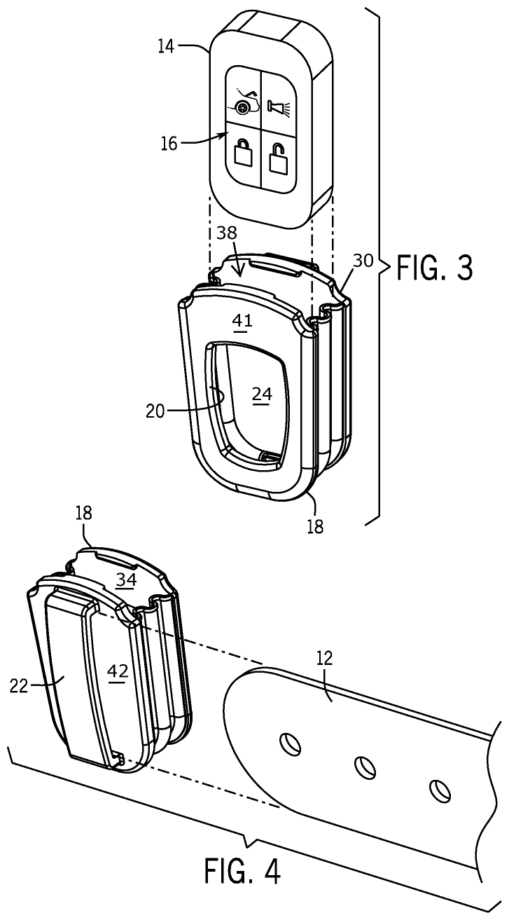

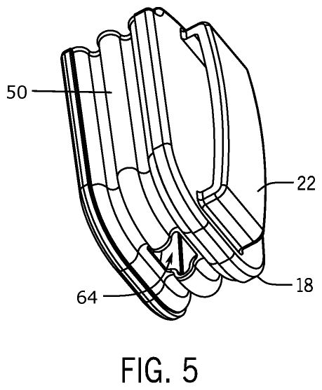

Referring to FIGS. 1 through 5, the present invention may include a carrier device 10 for securing an electronic device 14, such as a fob, wherein the electronic device is easily movable between an operative condition, secured within an enclosure 38 of the carrier device 10 and a detached condition separated from the carrier device. The carrier device 10 is adapted to removably attached to a belt or otherwise be wearable.

The carrier device 10 may be a unitary construction forming a body 18. The body 18 may be made from various durable plasticized materials amendable to injection molding, additive manufacture or the like. The carrier device 10 may provide the enclosure 38 dimensioned and adapted to slidably receive the electronic device 14 through an access opening 34. An access opening periphery 30 of said access opening 34 may be provided by the carrier device 10. The body 18 may provide a first end wall 41 spaced apart from a generally coextensive second end wall 42. Interconnecting the respective peripheries of the first and second end walls 41 and 42, except for those portions shared with the access opening periphery 30 is an accordion-like side wall 50. The first and second end walls 41 and 42 and the accordion-like side wall 50 defined the closed portions of the enclosure 38.

The relatively rigid accordion-like configuration of the side wall 50 enables flexibility in the end walls 41 and 42, results in lateral “give” of the body 18 which will result in a change of volume of the enclosure 38, when lateral forces (directed from the enclosure 38 outward in the direction of the end walls 41 and 42) are imposed, for example, when the electronic device 14 is slid into the enclosure 38. As a result, the end walls 41 and 42 will move further away from each other increasing the space and volume of the enclosure 38. At the same time, the rigidity of the accordion-like side wall 50 maintains a constant distance between its U-shaped legs when the electronic device 14 is housed in the enclosure, thereby “gripping” said electronic device 14 in such a biased state.

The first end wall 41 provides a display opening 24 defined by a display periphery 20 dimensioned to closely circumscribe a user interface 16 of the electronic device 14. Wherein the operative condition, the user interface 16 can be operatively engaged to, for example, lock or unlock and operative associated locking device.

The second end wall 42 may provide a loop 22 for slidably engaging an elongated member 12 of another object, such as a belt or wearable strap. A drain hole 64 may be provided along a lower portion of the accordion-like side wall 50 so that fixed keys or other items may be accommodated in part through the drain hole 64.

It should be understood by those skilled in the art that the use of directional terms such as lower, outward and the like are used in relation to the illustrative embodiments as they are depicted in the figures; the lower direction being toward the bottom of the corresponding figures; and the outward direction being away from the enclosure 38 shown in the corresponding figures.

A method of using the present invention may include the following. The carrier device 10 disclosed above may be provided. A user may attach the carrier device 10 to their person via a belt or other elongated member 12 through the loop 22. The user would then insert the electronic device 14, such as a key fob, into the enclosure 38 so that a user interface 16 of the electronic device 14 were visible and accessible through the display opening 24. This allows the user to become a permanent bearer of the electronic device 14, yet enabling immediate access to the various portions/buttons of the user interface 16. This will prevent loss of electronic devices 14 and electronic devices 14 from being accidentally left behind in a vehicle.

It should be understood, of course, that the foregoing relates to exemplary embodiments of the invention and that modifications may be made without departing from the spirit and scope of the invention as set forth in the following claims.

What is claimed is:

1. A carrier device for an electronic device having a user interface, comprising:
a body provide an access opening communicating an enclosure, both access opening and enclosure dimensioned to slidably receive the electronic device;
the enclosure defined by two spaced apart substantially coextensive first and second end walls and a sidewall interconnecting a periphery of each end wall except for a portion of each periphery shared with a periphery of the access opening; and
the first wall providing a display opening dimensioned to circumscribe the user interface.

2. The carrier device of claim 1, further comprising a connector disposed along the second end wall.

3. The carrier device of claim 2, wherein the connector is a loop.

4. The carrier device of claim 1, wherein the sidewall is accordion-like for enabling the two end walls to move relative to each other when urged from the enclosure.

5. The carrier device of claim 4, wherein the accordion-like sidewall is more rigid than the two spaced apart end walls in terms being movable in an outward direction from the enclosure.

6. The carrier device of claim 1, further comprising a drain hole provided along a lower portion of the sidewall.

7. The carrier device of claim 1, wherein the electronic device is a key fob.

8. The carrier device of claim 1, wherein the electronic device is movable through the access opening between a detached condition and an operable condition secured in the enclosure.

9. A carrier device for a key fob having a user interface, comprising:
a body provide an access opening communicating an enclosure, both access opening and enclosure dimensioned to slidably receive the key fob,
wherein the key fob is movable through the access opening between a detached condition and an operable condition secured in the enclosure;
the enclosure defined by two spaced apart substantially coextensive first and second end walls and an accordion-like sidewall interconnecting a periphery of each end wall except for a portion of each periphery shared with a periphery of the access opening;
the first wall providing a display opening dimensioned to circumscribe the user interface in the operable condition;
a loop disposed along the second end wall; and
a drain hole provided along a lower portion of the sidewall,
wherein the accordion-like sidewall enables the two end walls to move relative to each other when urged from the enclosure, and
wherein the accordion-like sidewall is less rigid than the two spaced apart end walls in terms being movable in an outward direction from the enclosure.
